(19) United States
(12) Patent Application Publication
(10) Pub. No.: US 2006/0069883 A1
(43) Pub. Date: Mar. 30, 2006

(54) Directory server and data processing method in directory server

(75) Inventor: Daisuke Shimizu, Nei (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/973,232

(22) Filed: Oct. 26, 2004

(30) Foreign Application Priority Data
Jun. 16, 2004 (JP) 2004-177708

(51) Int. Cl. G06F 13/00

(52) U.S. Cl. 711/154

(57) ABSTRACT

This invention is a technique to appropriately manage and use data before and after updating in a directory server. A data processing method executed by the directory server comprises: receiving first request data containing at least a first attribute value and concerning registration of an attribute into a particular entry and storing the first request data into a request data storage; generating first attribute data containing at least the first attribute value and data concerning a valid period of the first attribute value, and storing the first attribute data into a first attribute table; and storing an address of the first attribute table in which the first attribute data is stored, into an attribute management table corresponding to the particular entry. According to this method, as for the attribute, the attribute value is associated with data concerning the valid period of the attribute value. Therefore, a user can know which of the attribute values is currently valid, the period for which a particular attribute value was valid, and other information.

### TECHNICAL FIELD OF THE INVENTION

The present invention relates to a directory server, and more particularly, to data management and data manipulation techniques for a directory server.

### BACKGROUND OF THE INVENTION

The importance of data management is increasing with the development of information processing technology. For example, JP-A-2000-112803 discloses a technique for informing a client terminal of the update of a data file. Namely, the technique includes a management unit which manages data files and client terminals which need the data files, an update decision unit which determines the presence or absence of an update of a data file, and an update information distribution unit which transfers predetermined information concerning an updated data file to a client terminal, and when the update of the data file is performed, the predetermined information concerning the updated data file is transferred to the client terminal which needs the updated data file.

In addition, for example, JP-A-11-213009 discloses a technique for preventing the destruction of the update history of a document by a user as well as the destruction of the history of a business process by a user. Namely, this technique provides a storage system, which is composed of a plurality of terminals and a host having a database (DB) storage device, which contains a document storage area for storing documents, an attribute storage area for storing document attribute files, and a manipulation log list storage area for storing creation/update information for documents or document attribute files. When a document is newly created at any of the terminals and the document is to be uploaded into the document storage area of the DB storage device, each of the terminals creates the document attribute file of the document, while the host stores the document into the document storage area, associates the document attribute file with the document and stores the associated document attribute file into the attribute storage area, and adds log information made of information indicative of the creation date and time of each of the document and the document attribute file, into the manipulation log list storage area.

On the other hand, there are many cases in which a directory server for hierarchically managing data is used for the management of user information and the like. The directory has the feature of being suitable for search processing but unsuitable for the management of data, which is frequently updated, for example because the directory do not support transactions. At present, LDAP (Lightweight Directory Access Protocol: RFC 1777, RFC 2251) is generally adopted for directory servers, but contains no mechanism to hold the update history of data, for example. Furthermore, because of the difference between the configurations of DBs, the techniques disclosed in the aforementioned Japanese Patent Laid-Open Publications cannot be simply applied to LDAP directory serves or the like.

### SUMMARY OF THE INVENTION

Therefore, an object of the invention is to provide a technique to appropriately manage and use data before and after updating in a directory server.

A data processing method according to the invention comprises: receiving first request data containing at least a first attribute value and concerning registration of an attribute into a particular entry, and storing the first request data into a request data storage; generating first attribute data containing at least the first attribute value and data concerning a valid period of the first attribute value, and storing the first attribute data into a first attribute table; and storing an address of the first attribute table in which the first attribute data is stored, into an attribute management table corresponding to the particular entry.

According to this method, as for the attribute, the attribute value is associated with data concerning the valid period of the attribute value. Therefore, a user can know which of the attribute values is currently valid, the period for which a particular attribute value was valid, and other information.

The data processing method may further comprise: receiving second request data containing at least a second attribute value and concerning an update of an attribute value for a particular attribute registered in the particular entry, and storing the second request data into the request data storage; registering an end date and time of the valid period of the attribute value for attribute data containing a currently valid attribute value for the particular attribute; generating second attribute data containing at least the second attribute value and a start date and time of the valid period of the second attribute value, on the basis of the second request data stored in the request data storage, and storing the second attribute data into a second attribute table; and storing the address of the second attribute table in which the second attribute data is stored, into the attribute management table corresponding to the particular entry.

As a result, it is possible to hold the attribute value before updating, without adding a new entry or a new attribute. Therefore, a new attribute need not be introduced and the increase of storage capacity is minimized, and the aforementioned method can be comparatively easily applied to the directory server. In addition, as for each attribute value, a user can know the start date and time of its valid period or the start date and time and the end date and time of the same.

In addition, the aforementioned registering may comprise: copying the attribute data containing the currently valid attribute value for the particular attribute; and registering the end date and time of the valid period of the attribute value for the attribute data of the copy source, and in the generating said second attribute data, the second attribute data is generated by using the copied attribute data. Accordingly, a plurality of attribute data sets are held with respect to the same attribute, and no problems easily occur during search with designation of a specific attribute.

The method may further comprise: receiving search request data containing at least a condition concerning a date and time, and storing the search request data into a search request data storage; extracting attribute data containing data concerning a valid period, which satisfies the condition concerning the date and time, on the basis of the search request data stored in the search request data storage, and storing the extracted attribute data into a result storage; and generating output data containing an attribute value contained in the attribute data stored in the result storage, and outputting the generated output data. According to this method, for example, a user can know an attribute value, which was valid at a designated date and time.

The method may further comprise: receiving search request data containing a condition concerning a date and time for the particular attribute, and storing the search request data into the search request data storage; extracting third attribute data containing data concerning a valid period, which satisfies the condition concerning the date and time, in accordance with the search request data stored in the search request data storage, and storing the third attribute data into a first result storage; extracting fourth attribute data relating to the particular attribute in accordance with the search request data stored in the search request data storage, and storing the fourth attribute data into a second result storage; specifying, as attribute data relating to the particular attribute which satisfies the condition concerning the date and time, attribute data which is common to the third attribute data stored in the first result storage and the fourth attribute data stored in the second result storage, and storing the specified attribute data into a search result storage; and generating output data containing an attribute value contained in the attribute data stored in the search result storage, and outputting the output data. As a result, for example, a user can know an attribute value, which was valid at a designated date and time with respect to the particular attribute.

Incidentally, it is also possible to create a program for causing a computer to execute the method according to the invention and the program may be stored in a storage medium or a storage device such as flexible disks, CD-ROMs, magneto-optical disks, semiconductor memories, and hard disk drives. The program may also be distributed via a network as digital signals. Incidentally, intermediate processing results are temporarily stored in a storage device such as a memory.

### BRIEF DESCRIPTION OF THE DRAWINGS

FIG. 1 is a diagram showing a system configuration in an embodiment of the invention;

FIG. 2 is a diagram showing functional blocks of a computer in the embodiment of the invention;

FIG. 3 is a schematic diagram showing an entry according to the embodiment of the invention;

FIG. 4 is a diagram showing one example of a table configuration of a registration data storage;

FIG. 5 is a flowchart showing a processing flow in the embodiment of the invention;

FIG. 6 is a diagram showing one example of LDIF for performing an update processing of data concerning the valid period of an attribute value;

FIG. 7 is a flowchart showing a processing flow of an attribute value update processing;

FIG. 8A is a first diagram showing one example of LDIF, which indicates the state of data;

FIG. 8B is a second diagram showing one example of LDIF, which indicates the state of data;

FIG. 8C is a third diagram showing one example of LDIF, which indicates the state of data;

FIG. 8D is a fourth diagram showing one example of LDIF, which indicates the state of data;

FIG. 9 is a flowchart showing the processing flow of search processing;

FIG. 10 is a first diagram showing one example of LDIF, which indicates a search filter and the search result thereof;

FIG. 11 is a second diagram showing one example of LDIF, which indicates a search filter and the search result thereof;

FIG. 12 is a third diagram showing one example of LDIF, which indicates a search filter and the search result thereof;

FIG. 13 is a fourth diagram showing one example of LDIF, which indicates a search filter and the search result thereof;

FIG. 14 is a fifth diagram showing one example of LDIF, which indicates a search filter and the search result thereof;

FIG. 15 is a diagram showing an entry according to a first method; and

FIG. 16 is a diagram showing an entry according to a second method.

### DETAILED DESCRIPTION OF THE PREFERRED EMBODIMENTS

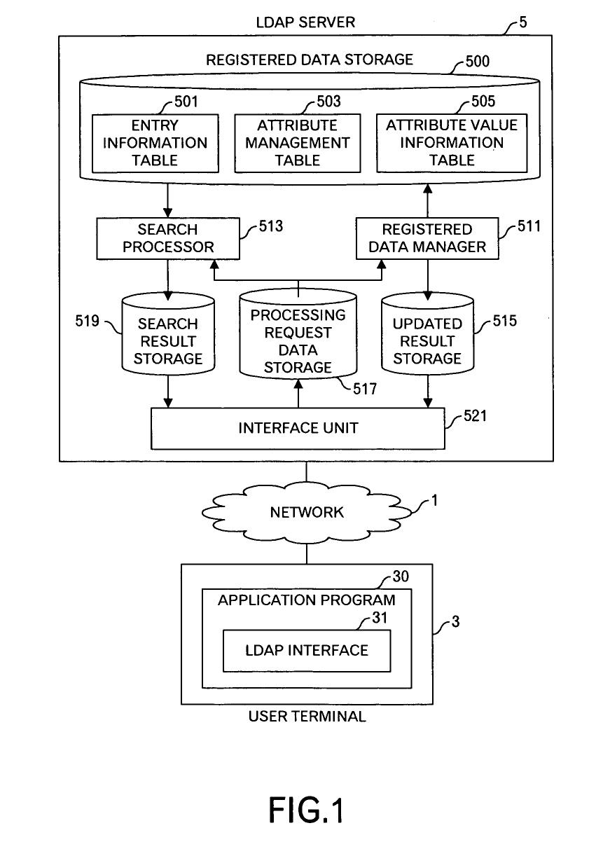

A system configuration according to one embodiment of the invention is shown in FIG. 1. An LDAP server 5 and one or a plurality of user terminals 3 are connected to a network 1, which is the Internet, for example, by the wire or wireless. The LDAP server 5 includes a registered data storage 500, a registered data manager 511, a search processor 513, an updated result storage 515, a processing request data storage 517, a search result storage 519, and an interface unit 521. The registered data manager 511 carries out a processing referring to the processing request data storage 517, and registers data into the registered data storage 500 and the updated result storage 515. The search processor 513 carries out a processing referring to the processing request data storage 517 and the registered data storage 500, and registers data into the search result storage 519. In addition, the interface unit 521 has a function for carrying out communication with the user terminal 3 via the network 1, and stores data received from the user terminal 3 into the processing request data storage 517 and carries out a processing referring to the updated result storage 515 and the search result storage 519, and transmits data to the user terminal 3. The registered data storage 500 includes an entry information table 501, an attribute management table 503 and an attribute value information table 505.

The user terminal 3 includes an application program 30, which carries out a processing using the LDAP server 5. The application program 30 includes an LDAP interface 31, which is an interface for accessing the LDAP server 5.

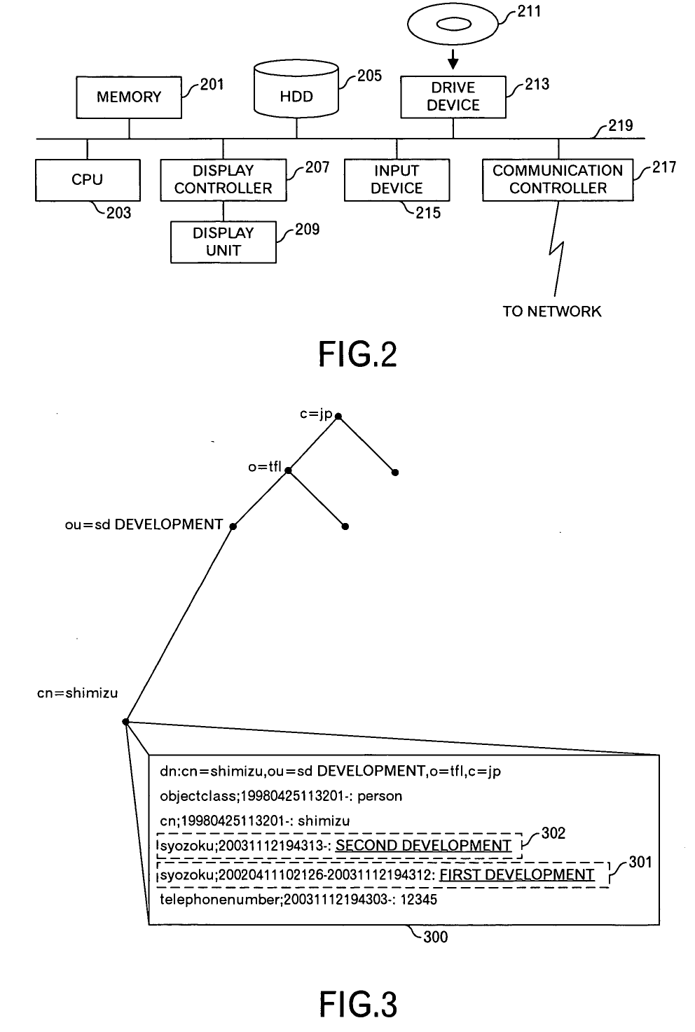

Incidentally, each of the LDAP server 5 and the user terminal 3 is a computer system as shown in FIG. 2, and a memory 201, a CPU 203, a hard disk drive (HDD) 205, a display controller 207 connected to a display device 209, a drive device 213 for a removable disk 211, an input device 215 and a communication controller 217 for connection to the network are connected to one another by a bus 219. An operating system (OS) and an application program including a program for realizing a processing in this embodiment are stored in the HDD 205, and when the application program is executed by the CPU 203, the application program is read out from the HDD 205 to the memory 201. As the occasion demands, the CPU 203 controls the display unit 207, the communication controller 217 and the drive device 213 to cause each of them to perform the necessary operations. In addition, data, which is being processed, is stored in the memory 201, and if necessary, is stored in the HDD 205. The program for realizing the processing in this embodiment is stored in the removable disk 211 and distributed, or is received via the network and the communication controller 217, and then it is installed into the HDD 205. In this computer system, the aforementioned hardware such as the CPU 203 and the memory 201 and the OS as well as the necessary application programs systematically cooperate with one another to realize various functions, which will be described below.

FIG. 3 is a schematic diagram showing an entry in this embodiment. FIG. 3 shows an example in which the attribute “syozoku” is modified from “first development” to “second development” with respect to an entry whose dn (Distinguished Name) is “cn=shimizu, ou=sd development, o=tfl, c=jp”. Incidentally, cn, ou, o and c represent Common Name, Organization Unit, Organization, and Country, respectively. In LDAP, individual records to be stored are called entries, and discrimination of the entries is carried out on the basis their dn. Each of the entries can have, for example, plural attributes, and the respective attributes have values (attribute values).

Although a processing method will be described later in detail, each of the attributes in an entry 300 is associated with the start date and time of the valid period of the attribute value or the start date and time and the end date and time of the valid period of the attribute value. Accordingly, the update history of an arbitrary attribute value can be managed by using time information. For example, an attribute 301 and an attribute 302 indicate one attribute value at a particular date and time. The attribute 301 indicates “first development” which is a value before update, and further indicates the valid period “20020411102126-20031112194312” of “first development”. “20020411102126-20031112194312” indicates the period from Apr. 11, 2002 10:21:26 to Nov. 12, 2003 19:43:12.

The attribute 302 indicates “second development” which is a value after update, and further indicates the start date and time “20031112194313-” of the valid period for “second development”. The hyphen added at the end of the start date and time indicates that the value is valid up to the present time. In this embodiment, in this manner, plural attribute values are held for different valid periods with respect to the same attribute (syozoku).

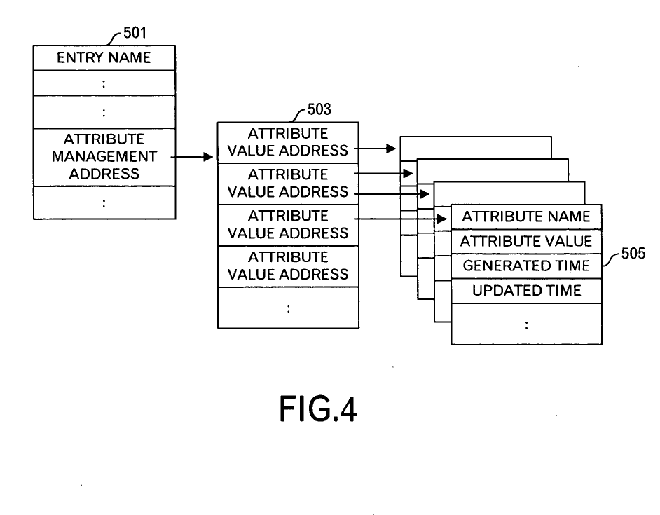

FIG. 4 shows a schematic diagram of the table configuration of the registered data storage 500. The entry information table 501 is generated in units of entries, and an entry name, an attribute management address and the like are registered in the entry information table 501. The attribute management address is the address of the attribute management table 503, which corresponds to the entry information table 501. The attribute management table 503 is generated in units of entries, and the attribute value addresses of attributes included in the entry are registered in the attribute management table 503. The attribute value addresses are the addresses of the attribute value information tables 505, which correspond to the respective attribute values. In a case where plural attribute values are associated with the same attribute, the attribute value information table 505 and the attribute value address exist so as to correspond to each of the plural attribute values. Data such as attribute name, attribute value, generated time and updated time is stored in each of the attribute value information tables 505 generated in units of attribute values. The generated time is the date and time when the pertinent attribute value information table 505 was generated, and means the start date and time of the valid period of the attribute value. The updated time is the date and time when the pertinent attribute value information table 505 was updated, and means the end date and time of the valid period of the attribute value.

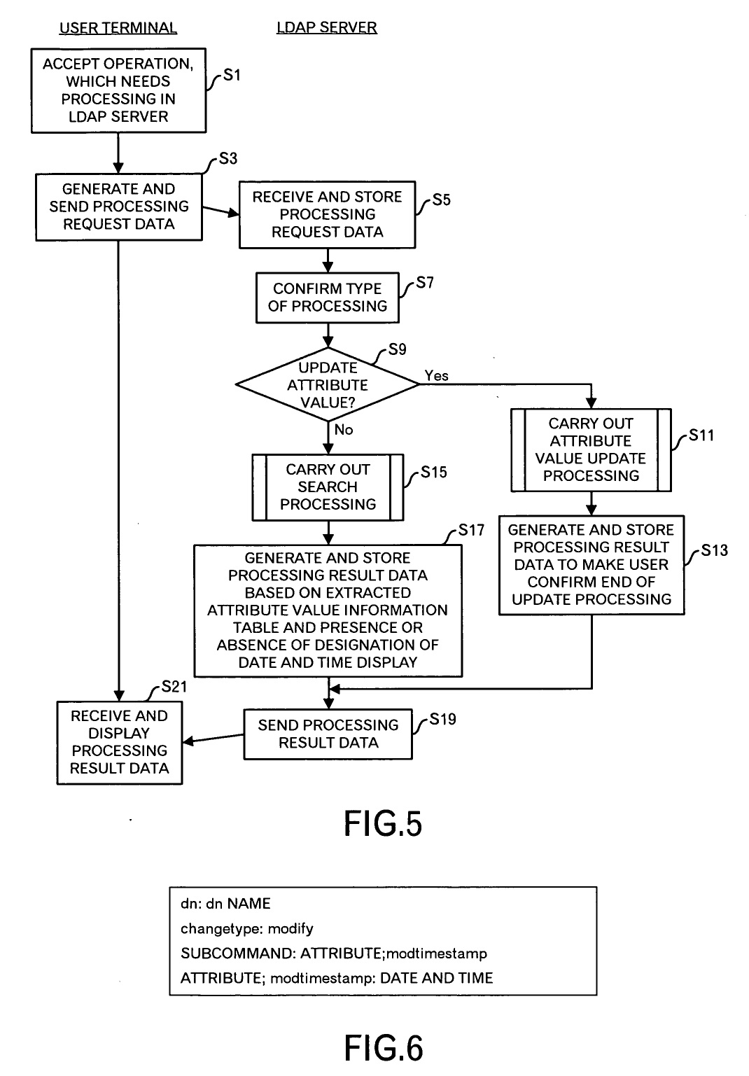

The processing of the system shown in FIG. 1 will be described below with reference to FIGS. 5 to 14. First, the application program 30 of the user terminal 3 accepts an operation by a user, which needs the processing in the LDAP server 5 (FIG. 5: Step S1). The application program 30 generates processing request data, and transmits the processing request data to the LDAP server 5 (Step S3). In this processing, the LDAP interface 31 is used.

The interface unit 521 of the LDAP server 5 receives the processing request data from the user terminal 3, and stores the processing request data in the processing request data storage 517 (Step S5). The interface unit 521 confirms the type of processing of the processing request data stored in the processing request data storage 517 (Step S7). It is assumed here that the type of processing is either an update or a search for an attribute value.

Incidentally, an update of data concerning the valid period of the attribute value can also be carried out. FIG. 6 shows an example of LDIF (LDAP Data Interchange Format) to carry out the update of the data concerning the valid period of the attribute value. Actually, for example, “replace” is designated as a subcommand, “syozoku” as an attribute, and the value “20031224105648” as the date and time. The designation “modtimestamp” means that the update date and time of an attribute value, i.e., the end date and time of the valid period of the attribute value, should be updated. In a case where the generated date and time of an attribute value, i.e., the start date and time of the valid period of the attribute value, are to be updated, the designation “addtimestamp” is made instead of “modtimestamp”. In the example shown in FIG. 6, in a case where plural attribute values exist, the date and time to be updated are, for example, the latest generated or updated date and time. Namely, if the designation “addtimestamp” is made, the start date and time of the valid period of the currently valid attribute value are updated. On the other hand, because the currently valid attribute value is not associated with the end date and time of the valid period, if the designation “modtimestamp” is made, the end date and time of the valid period of an attribute value which was valid one generation ago are updated. Incidentally, it is possible that values (date and time) before and after the update can be designated, and the update can be performed irrespective of generations.

Returning to the description of FIG. 5, the interface unit 521 of the LDAP server 5 determines whether the type of processing is an update of the attribute value (FIG. 5: Step S9). If it is determined that the type of processing is the update of the attribute value (Step S9: Yes route), the registered data manager 511 of the LDAP server 5 performs an attribute value update processing (Step S11). The details of the attribute value update processing will be described later. The interface unit 521 of the LDAP server 5 generates processing result data for causing the user to confirm the end of the update processing, and temporarily stores the processing result data in a storage device such as a work memory area (Step S13). For example, output data including a confirmation message and/or attribute values before and after the update are generated as the processing result data.

On the other hand, if it is determined that the type of processing is not an update of the attribute value (Step S9: No route), the search processor 513 of the LDAP server 5 performs search processing (Step S15). Although the details of the search processing will be described later, an attribute value information table 505, which satisfies search conditions, is extracted, and it is stored in the search result storage 519.

Then, the interface unit 521 of the LDAP server 5 generates processing result data on the basis of the attribute value information table 505 extracted in the search processing at the Step S15 and the presence or absence of a designation of date and time display in the processing request data, and temporarily stores processing result data in the storage device such as a work memory area (Step S17). Although a specific example will be described later, it is determined according to the type of search whether date and time for the valid period of the attribute value are to be outputted. Then, the processing proceeds to the processing at Step S19, which will be described later.

The interface unit 521 transmits the processing result data generated at the Step S13 or Step S17 to the user terminal 3 (Step S19). The application program 30 of the user terminal 3 receives the processing result data from the LDAP server 5 by using the LDAP interface 31, and displays the received processing result data on the display device (Step S21).

In this manner, the aforementioned sequence of processing using the LDAP server 5 is performed.

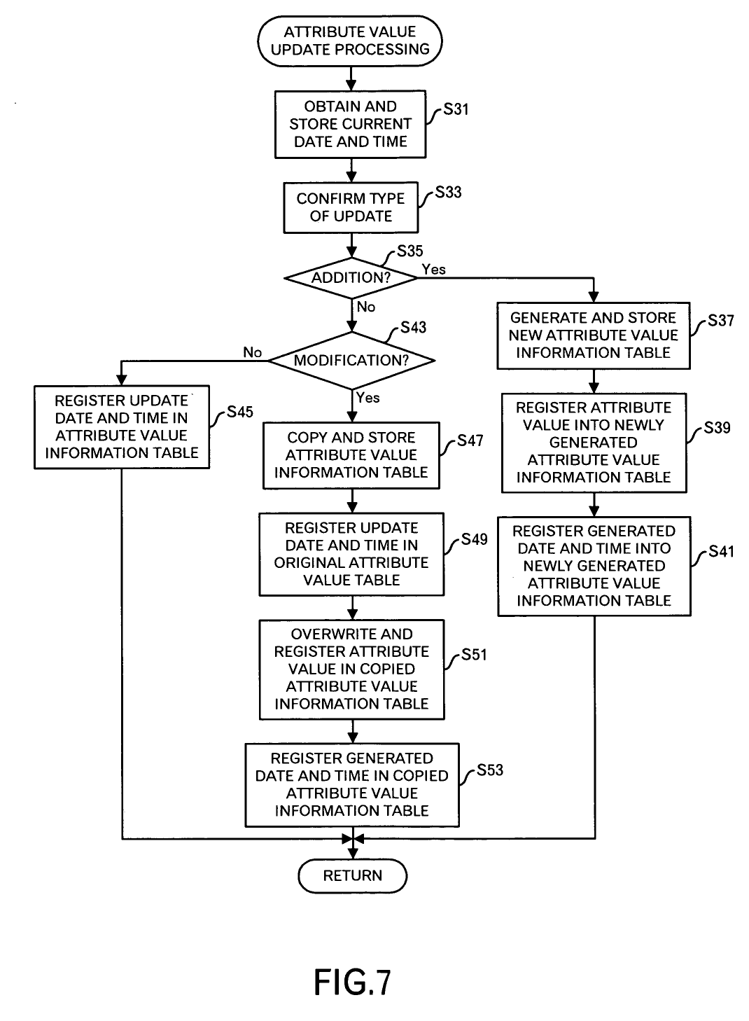

The details of the attribute value update processing (FIG. 5: Step S11) will be described with reference to FIG. 7. The registered data manager 511 of the LDAP server 5 acquires the current date and time from the system clock or the like, and temporarily stores them in the storage device such as a work memory area (FIG. 7: Step S31). The registered data manager 511 confirms the type of update (Step S33). It is assumed here that the type of update is any of addition, deletion and modification of an attribute value. Then, the registered data manager 511 determines whether the type of update is addition (Step S35). If it is determined that the type of update is addition (Step S35: Yes route), the registered data manager 511 generates a new attribute value information table 505, and stores the new attribute value information table 505 in the registered data storage 500 (Step S37). At this time, the registered data manager 511 registers the address of the newly generated attribute value information table 505 in the attribute management table 503. In addition, the registered data manager 511 registers an attribute value in the newly generated attribute value information table 505 (Step S39). Furthermore, the registered data manager 511 registers the generated date and time in the newly generated attribute value information table 505 (Step S41). As described above, the generated date and time means the start date and time of the valid period of the attribute value. For example, the current date and time acquired at the Step S31 is registered as the generated date and time. Then, the processing returns to the original processing.

On the other hand, it is determined that the type of update is not addition (Step S35: No route), the registered data manager 511 determines whether the type of update is modification (Step S43). If it is determined that the type of update is not modification (but deletion) (Step S43: No route), the registered data manager 511 registers the update date and time in the attribute value information table 505 corresponding to the currently valid attribute value (Step S45). As described above, the update date and time means the end date and time of the valid period of the attribute value. For example, the current date and time acquired at the Step S31 is registered as the update date and time. Then, the processing returns to the original processing.

On the other hand, if it is determined that the type of update is modification (Step S43: Yes route), the registered data manager 511 copies an attribute value information table 505 corresponding to the currently valid attribute value, and stores the copied attribute value information table 505 in the registered data storage 500 (Step S47). Then, the registered data manager 511 registers the update date and time in the original attribute value information table 505 (Step S49). For example, the current date and time acquired at the Step S31 is registered as the update date and time. In addition, the registered data manager 511 overwrites and registers the attribute value in the copied attribute value information table 505 (Step S51). Furthermore, the registered data manager 511 registers the generated date and time in the copied attribute value information table 505 (Step S53). For example, the date and time one second after the current date and time acquired at the Step S31 are registered as the generated date and time. Then, the processing returns to the original processing.

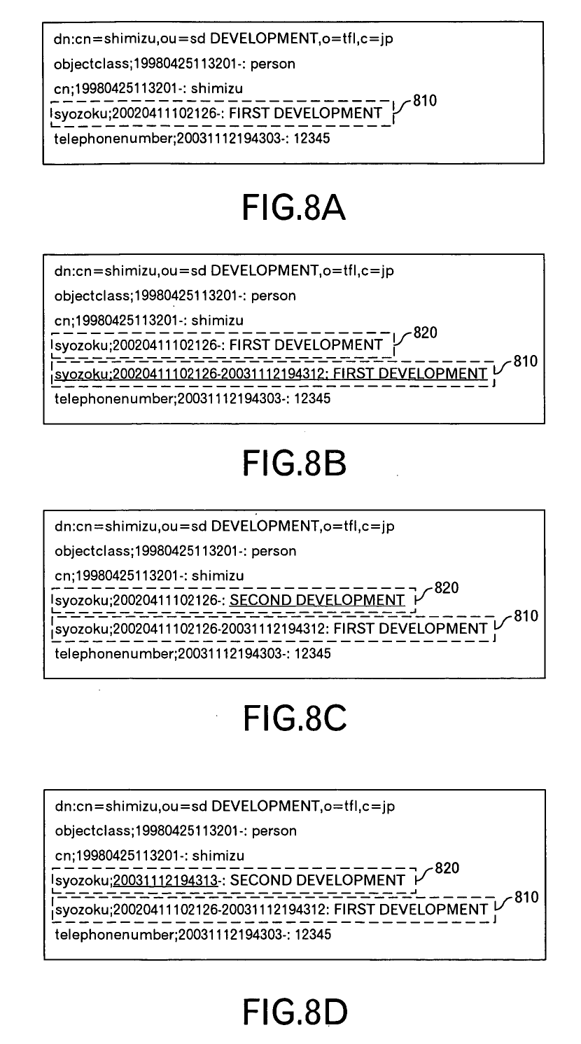

In this manner, the attribute value update processing is performed. FIGS. 8A to 8D show examples of LDIF to represent the states of data from the Steps S47 to S53 (FIG. 7). An attribute 810 in FIG. 8A corresponds to one attribute value information table 505, and indicates that the current valid attribute value of the attribute “syozoku” is “first development”. In a case where the processing to modify this attribute value “first development” into “second development” is carried out, the registered data manager 511 first copies the attribute 810 (Step S47). Namely, the registered data manager 511 copies the attribute value information table 505 corresponding to the attribute 810. FIG. 8B shows a copied attribute 820. Then, the registered data manager 511 registers the update date and time into the original attribute 810 (Step S49). FIG. 8B shows the state in which the update date and time is registered in the original attribute 810.

Then, the registered data manager 511 overwrites and registers the attribute value “second development” into the copied attribute 820 (Step S51). FIG. 8C shows the state in which the attribute value “second development” is overwritten and registered in the copied attribute 820. Furthermore, the registered data manager 511 registers the generated date and time in the copied attribute 820 (Step S53). FIG. 8D shows the state in which the generated date and time are registered in the copied attribute 820. In this manner, the modification of the attribute value is carried out. Although the example of generating the attribute 820 by copying the attribute 810 has been explained above, the attribute 820 after updating may be newly generated.

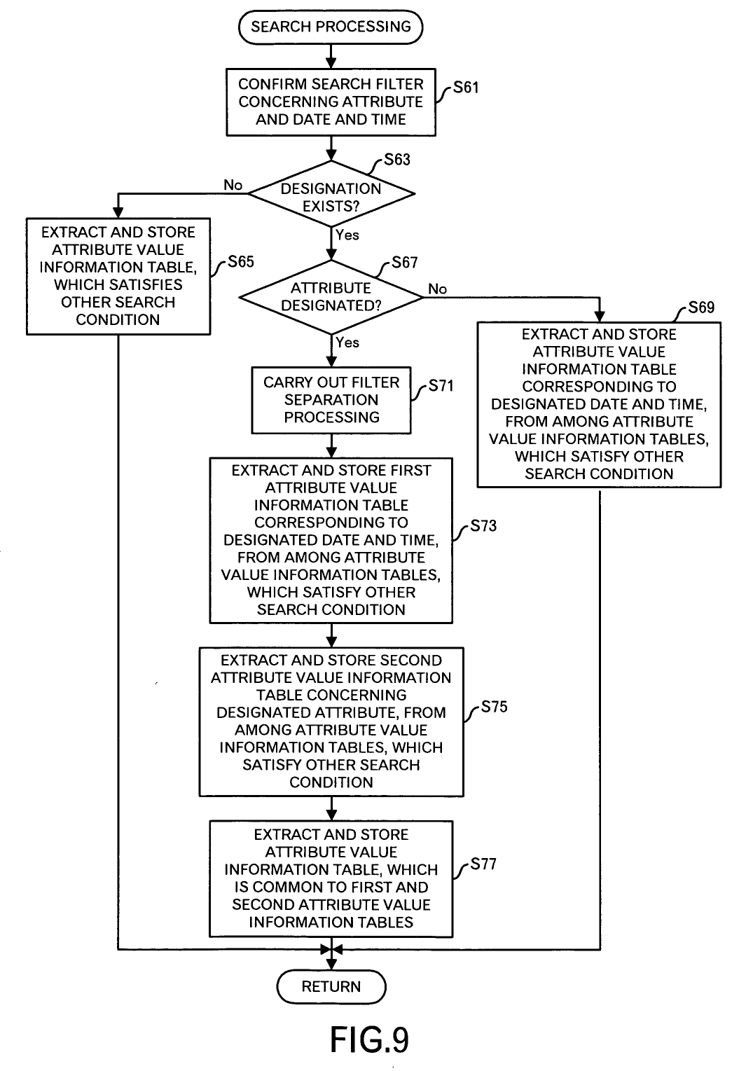

The details of the search processing (FIG. 5: Step S15) will be described below in detail with reference to FIG. 9. First, the search processor 513 of the LDAP server 5 refers to the processing request data storage 517 and confirms a search filter concerning an attribute and a date and time for this search processing (FIG. 9: Step S61). A specific example of the search filter will be described later. Then, the search processor 513 determines whether a designation is made as to at least either the attribute or the date and time (Step S63). If it is determined that no designation is made as to at least either the attribute or the date and time (Step S63: No route), the search processor 513 extracts a attribute value information table 505 which satisfies other search condition, and stores the extracted attribute value information table 505 in the search result storage 519 (Step S65). The other search condition means a designation of “cn” or the like. Then, the processing returns to the original processing.

On the other hand, if it is determined that a designation is made as to at least either the attribute or the date and time (Step S63: Yes route), the search processor 513 determines whether a designation is made as to the attribute (Step S67). If it is determined that no designation is made as to the attribute (i.e. a designation is made as to the date and time) (Step S67: No route), the search processor 513 extracts an attribute value information table 505 corresponding to the designated date and time, from among attribute value information tables 505 which satisfy the other search condition, and stores the extracted attribute value information table 505 into the search result storage 519 (Step S69). Then, the processing returns to the original processing.

On the other hand, if it is determined that a designation is made as to the attribute (a designation is made as to the date and time as well) (Step S67: Yes route), the search processor 513 carries out a filter separation processing(Step S71). Namely, the search processor 513 separates the designation of the attribute and the designation of the date and time. Then, the search processor 513 identifies a first attribute value information table 505 corresponding to the designated date and time, from among the attribute value information tables 505 which satisfy the other search conditions, and temporarily stores the first attribute value information table 505 into the storage device such as a work memory area (Step S73). In addition, the search processor 513 identifies a second attribute value information table 505 concerning the designated attribute, from among the attribute value information tables 505 which satisfy the other search conditions, and temporarily stores the second attribute value information table 505 into the storage device such as a work memory area (Step S75). Furthermore, the search processor 513 extracts an attribute value information table 505, which is common to the first attribute value information table 505 and the second attribute value information table 505, and stores the extracted attribute value information table 505 into the search result storage 519 (Step S77). Then, the processing returns to the original processing.

The search processing is performed in this manner, and the processing result data to be presented to the user is generated on the basis of the attribute value information table 505 stored in the search result storage 519 by the processing at any of the Steps S65, S69 and S77.

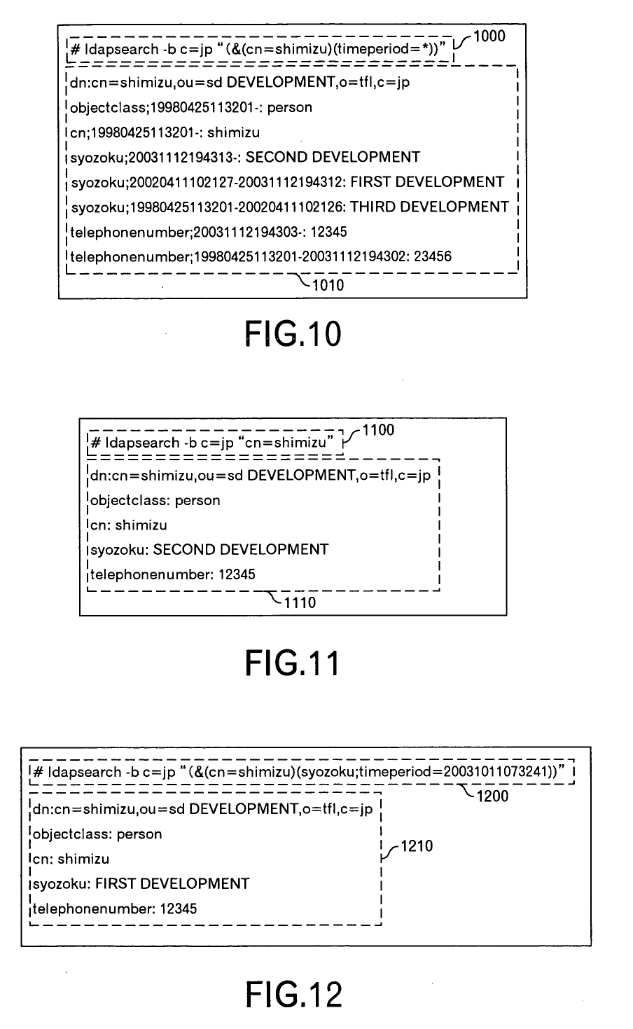

FIGS. 10 to 14 show an example of LDIF, which represents a specific search filter and a search result. In a search command 1000 of FIG. 10, the search condition “cn=shimizu” and the search filter “timeperiod=*”, concerning a date and time are indicated. Incidentally, “*” (asterisk) means that no particular value is designated, and if a date and time is designated, it is determined that a designation of date and time display is made. Because no designation to the attribute is made, the processing proceeds through the Step S69 in the processing flow of FIG. 9. In a search result 1010, the results of the search processing based on the search command 1000 are indicated. Namely, with respect to attributes which satisfy “cn=shimizu”, data concerning attribute values and the valid periods thereof are indicated. For example, as for the attribute “syozoku”, it is indicated that after its attribute value is modified from “third development” to “first development”, the attribute value is modified from “first development” to “second development”, and the current valid attribute value is “second development”. In this manner, for example, the user can easily know attribute values before updating and the valid periods of the respective attribute values. Incidentally, the valid periods of the respective attribute values are indicated when a designation of date and time display is made.

In a search command 1100 of FIG. 11, the search condition “cn=shimizu” is indicated. Because neither a date and time nor an attribute is designated, the processing proceeds through the Step S65 in the processing flow of FIG. 9. In a search result 1110, the results of search processing based on the search command 1100 are indicated. Namely, as for attributes which satisfy “cn=shimizu”, the current valid attribute values are indicated. Accordingly, even in the case of an application program, which does not support the designation of the date and time, the LDAP server 5 can be used without modification.

In a search command 1200 of FIG. 12, the search condition “cn=shimizu” and the search filter “syozoku; timeperiod=20031011073241” concerning an attribute and a date and time are indicated. Because the attribute and the date and time are designated, the processing proceeds through the Steps S71 to S77 in the processing flow of FIG. 9. First of all, in the Step S71, the filter is separated into “syozoku=*” for attribute designation and “timeperiod=20031011073241” for designation of the date and time. Then, at the Step S73, data of attribute values which satisfy “cn=shimizu” and the date and time “20031011073241” are extracted. For example, the data “syozoku; 20020411102127-20031112194312: first development” and “telephonenumber; 19980425113201-20031112194302: 23456” are extracted.

At the Step S75, data of attribute values which satisfy “cn=shimizu” and the attribute “syozoku=*” are extracted. For example, the data “syozoku; 20031112194313: second development”, “syozoku; 20020411102127-20031112194312: first development” and “syozoku; 19980425113201-20020411102126: third development” are extracted. Furthermore, at the Step S77, data, which is common to the data of the attribute values specified at the Step S73 and the data of the attribute values specified at the Step S75, is extracted. In the above example, the data “syozoku; 20020411102127-20031112194312: first development” is extracted.

In a search result 1210, the results of the search processing based on the search command 1200 are indicated. Namely, as for attributes which satisfy “cn=shimizu”, attribute values are indicated. However, as for the attribute “syozoku”, the attribute value “first development” which was valid at the date and time “20031011073241” is indicated, while as for the other attributes, their current valid attribute values are indicated. Incidentally, at the Step S77 (FIG. 9), only one data item, for example, “syozoku: 20020411102127-20031112194312: development” is extracted, so that at the Step S17 (FIG. 5), with respect to the other attributes which satisfy “cn=shimizu”, their current valid attribute values are specified, and processing result data are generated. For example, the attribute value “12345” is specified from the data “telephonenumber; 20031112194303-: 12345”, and is used for the generation of the processing result data. In this manner, for example, as for an attribute for which “timeperiod” is designated, the user can know an attribute value, which was valid at the designated point in time, and as for the other attributes, the user can know their current valid attribute values.

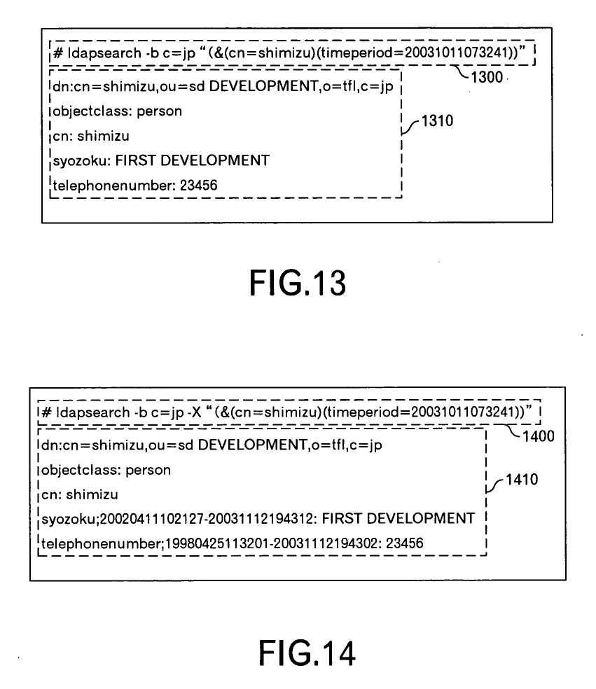

In a search command 1300 of FIG. 13, the search condition “cn=shimizu” and the search filter “timeperiod=20031011073241” concerning a date and time are indicated. Because an attribute is not designated, the processing proceeds through the Step S69 in the processing flow of FIG. 9. In a search result 1310, the results of the search processing based on the search command 1300 are indicated. Namely, as for attributes which satisfy “cn=shimizu”, attribute values which were valid at the designated date and time are indicated. The difference between the search result 1210 in FIG. 12 and the search result 1310 resides in the attribute values of the attribute “telephonenumber”. In the search result 1210, the current valid attribute value “12345” is indicated, whereas in the search result 1310, the attribute value “23456” which was valid at the designated date and time is indicated. In this manner, for example, the user can know an attribute value, which was valid at a particular point in time.

In a search command 1400 of FIG. 14, the option parameter “-X”, the search condition “cn=shimizu” and the search filter “timeperiod=20031011073241” concerning a date and time are indicated. The operation parameter “-X” means a designation of date and time display. Because an attribute is not designated, the processing proceeds through the Step S69 in the processing flow of FIG. 9. In a search result 1410, the results of the search processing based on the search command 1400 are indicated. Namely, as for attributes which satisfy “cn=shimizu”, attribute values, which were valid at the designated date and time, and the valid periods of the attribute values are indicated. In this manner, for example, the user can know attribute values, which were valid at a particular point in time, as well as the valid periods of the attribute values.

As described above, the processing of the system shown in FIG. 1 is performed. Accordingly, it is possible to appropriately manage and use data before and after updating in a directory server.

Incidentally, there is a possibility that two methods, which will be described below, are adopted in the case where data before updating is held in a LDAP server.

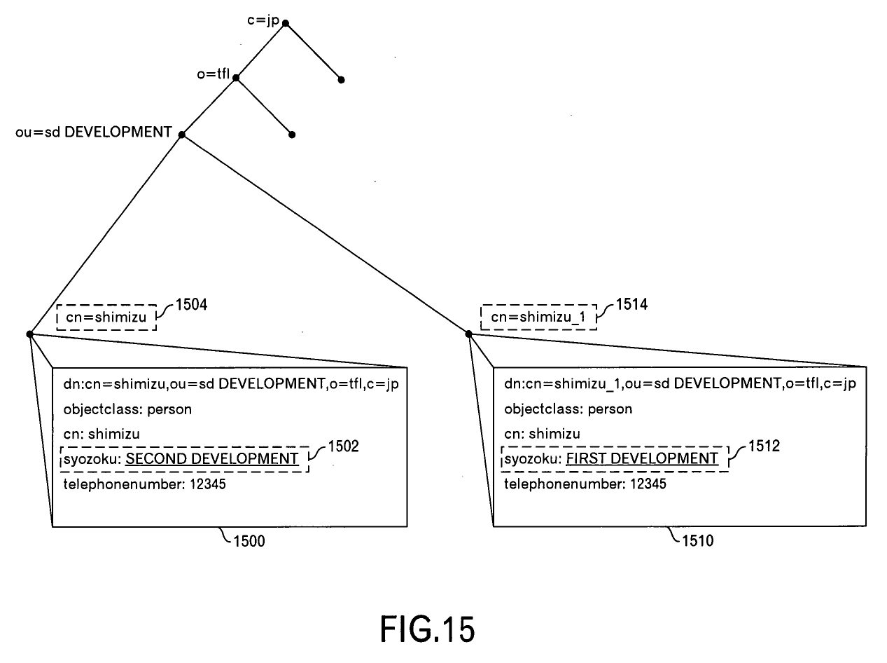

FIG. 15 shows a schematic diagram of an entry according to the first method. FIG. 15 shows an example in which the value of the attribute “syozoku” is modified from “first development” to “second development” with respect to an entry whose dn is “cn=shimizu, ou=sd development, o=tfl, c=jp”.

As for the processing method, first, the entry, which holds the attribute to be updated, is copied by the use of another dn (for example, “cn=shimizu_1, ou=sd development, o=tfl, c=jp”). The copied entry is indicated as an entry 1510 in FIG. 15. “First development” which is a value before updating is indicated in an attribute 1512 of the entry 1510. In addition, as indicated in a cn value 1514, dn is modified by modifying cn from “shimizu” to “shimizu_{—}138 . Namely, the entry before updating is saved together with the modified name.

Then, the attribute of the original entry is updated. The updated entry is indicated as an entry 1500 in FIG. 15. In an attribute 1502 of the entry 1500, “second development” which is a value after updating is indicated. In addition, as indicated in a cn value 1504, the value of cn is not modified, and the value of dn also is not modified. The method of making a backup of an entry in this manner is the first method.

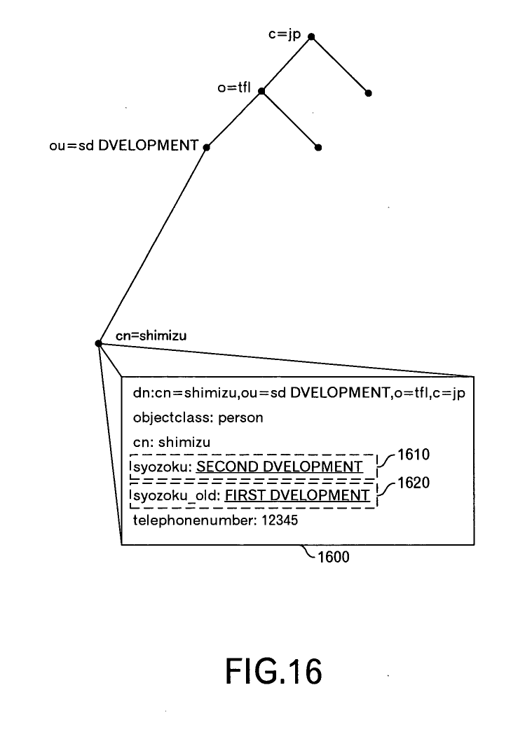

FIG. 16 shows a schematic diagram of an entry according to the second method. Similarly to FIG. 15, FIG. 16 shows an example in which the value of the attribute “syozoku” is modified from “first development” to “second development” with respect to the entry whose dn is “cn=shimizu, ou=sd development, o=tfl, c=jp”.

In the processing method, first, the attribute to be updated is copied as another attribute. The copied attribute is indicated as an attribute 1620 in FIG. 16. “first development” which is a value before updating is indicated in the attribute 1620. Namely, the entry before updating is saved in the same entry 1600 together with the modified name.

Then, the original attribute is updated. The updated attribute is indicated as an attribute 1610 in FIG. 16. In the attribute 1610, “second development” which is a value after updating is indicated. The method of making a backup of an attribute in this manner is the second method.

However, these first and second methods have the following problems compared to the aforementioned embodiment. In the case where an old attribute value of an entry is managed in another entry like the first method shown in FIG. 15, entries need to be added by the number of old attribute values to be held. In general and in many cases, the license fee of an LDAP server is determined by the number of entries, and as the number of entries increases, the license fee rises, leading to a cost increase. Furthermore, information needs to be held in two or more entries as to one target (for example, a user). In this case, data update processing becomes complicated, and is likely to cause various problems.

In the case where an old attribute value is managed in another attribute like the second method shown in FIG. 16, updating is not accompanied by the addition of an entry, but lookup becomes difficult. Namely, in order to look up the old attribute value, the attribute different from that of the current attribute value needs to be designated when actual search, leading to a problem that if the user does not know by what attribute (name) the old attribute value is saved, the user cannot look up the old attribute value, for example.

Accordingly, by adopting the method mentioned in the above description of this embodiment, it is possible to realize appropriate management and use of data.

Although one embodiment of the invention has been described above, the invention is not limited to this particular embodiment. For example, the table configuration shown in FIG. 4 is merely one example, and another configuration, which can store similar kinds of data may also be adopted, and as the occasion demands, items may be added or deleted. The functional block configurations of the LDAP server and the user terminal shown in FIG. 1 are merely one example, and actual program module configurations may also differ from the shown functional block configurations. Similarly, the functional block diagram of the computer shown in FIG. 2 is merely one example, and actual hardware configurations may also differ from the shown configuration. The LDAP server may also be composed of a plurality of servers. Any of the schematic diagrams shown in FIGS. 3, 15 and 16 is merely one example, and similar contents may also be represented in other forms. The description of any of the LDIFs shown in FIGS. 6, 8A to 8D and 10 to 14 is merely one example, and similar contents may also be represented in other forms. Furthermore, any of the processing flows shown in FIGS. 5, 7 and 9 is merely one example, and as the occasion demands, the sequence of the processing may also be changed, or a step or steps may also be added or deleted within the range in which similar processing results can be attained.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A data structure managed by a directory server, comprising:
attribute data defining data concerning an attribute item;
attribute management data defining a storage address of said attribute data corresponding to each of said attribute items included in one entry; and
entry management data defining a storage address of said attribute management data corresponding to each of said entries, and
wherein said attribute data comprises at least an attribute value and data concerning a valid period of said attribute value, and
in a case where a plurality of attribute items are defined for one attribute, said attribute management data defines a storage address of said attribute data for each of said attribute items.

2. A data processing method, comprising:
receiving first request data containing at least a first attribute value and concerning registration of an attribute into a particular entry, and storing said first request data into a request data storage;
generating first attribute data containing at least said first attribute value and data concerning a valid period of said first attribute value, and storing said first attribute data into a first attribute table; and
storing an address of said first attribute table storing said first attribute data, into an attribute management table corresponding to said particular entry.

3. The data processing method as set forth in claim 2, further comprising:
receiving second request data containing at least a second attribute value and concerning an update of an attribute value for a particular attribute registered in said particular entry, and storing said second request data into said request data storage;
registering an end date and time of said valid period of said attribute value for attribute data containing a currently valid attribute value for said particular attribute;
generating second attribute data containing at least said second attribute value and a start date and time of said valid period of said second attribute value, based on said second request data stored in said request data storage, and storing said second attribute data into a second attribute table; and
storing an address of said second attribute table storing said second attribute data, into said attribute management table corresponding to said particular entry.

4. The data processing method as set forth in claim 3, wherein said registering comprises:
copying attribute data containing said currently valid attribute value for said particular attribute; and
registering said end date and time of said valid period of said attribute value in the original attribute data, and
wherein in said generating said second attribute data, said second attribute data is generated by using the copied attribute data.

5. The data processing method as set forth in claim 2, further comprising:
receiving search request data containing at least a condition concerning a date and time, and storing said search request data into a search request data storage;
extracting attribute data containing data concerning a valid period, which satisfies said condition concerning said date and time, based on said search request data stored in said search request data storage, and storing the extracted attribute data into a result storage; and
generating and outputting output data containing an attribute value contained in said attribute data stored in said result storage.

6. The data processing method as set forth in claim 2, further comprising:
receiving search request data containing a condition concerning a date and time for a particular attribute, and storing said search request data into a search request data storage;
extracting third attribute data containing data concerning a valid period, which satisfies said condition concerning said date and time, in accordance with said search request data stored in said search request data storage, and storing said third attribute data into a first result storage;
extracting fourth attribute data relating to said particular attribute in accordance with said search request data stored in said search request data storage, and storing the fourth attribute data into a second result storage;
specifying, as attribute data relating to said particular attribute, which satisfies said condition concerning said date and time, attribute data which is common to said third attribute data stored in said first result storage and said fourth attribute data stored in said second result storage, and storing the specified attribute data into a search result storage; and
generating and outputting output data containing an attribute value contained in said attribute data stored in said search result storage.

7. The data processing method as set forth in claim 5, wherein in said generating and outputting, if output instruction data of said data concerning said valid period of said attribute value is included in said search request data, said output data is generated so as to include said attribute value contained in said attribute data stored in said search result storage and said data concerning said valid period of said attribute value.

8. A program embodied on a medium for causing a computer to execute a data processing, said program comprising:
receiving first request data containing at least a first attribute value and concerning registration of an attribute into a particular entry, and storing said first request data into a request data storage;
generating first attribute data containing at least said first attribute value and data concerning a valid period of said first attribute value, and storing said first attribute data into a first attribute table; and
storing an address of said first attribute table storing said first attribute data, into an attribute management table corresponding to said particular entry.

9. The program as set forth in claim 8, further comprising:
receiving second request data containing at least a second attribute value and concerning an update of an attribute value for a particular attribute registered in said particular entry, and storing said second request data into said request data storage;
registering an end date and time of said valid period of said attribute value for attribute data containing a currently valid attribute value for said particular attribute;
generating second attribute data containing at least said second attribute value and a start date and time of said valid period of said second attribute value, based on said second request data stored in said request data storage, and storing said second attribute data into a second attribute table; and
storing an address of said second attribute table storing said second attribute data, into said attribute management table corresponding to said particular entry.

10. The program as set forth in claim 9, wherein said registering comprises:
copying attribute data containing said currently valid attribute value for said particular attribute; and
registering said end date and time of said valid period of said attribute value in the original attribute data, and
wherein in said generating said second attribute data, said second attribute data is generated by using the copied attribute data.

11. The program as set forth in claim 8, further comprising:
receiving search request data containing at least a condition concerning a date and time, and storing said search request data into a search request data storage;
extracting attribute data containing data concerning a valid period, which satisfies said condition concerning said date and time, based on said search request data stored in said search request data storage, and storing the extracted attribute data into a result storage; and
generating and outputting output data containing an attribute value contained in said attribute data stored in said result storage.

12. The program as set forth in claim 8, further comprising:
receiving search request data containing a condition concerning a date and time for a particular attribute, and storing said search request data into a search request data storage;
extracting third attribute data containing data concerning a valid period, which satisfies said condition concerning said date and time, in accordance with said search request data stored in said search request data storage, and storing said third attribute data into a first result storage;
extracting fourth attribute data relating to said particular attribute in accordance with said search request data stored in said search request data storage, and storing the fourth attribute data into a second result storage;
specifying, as attribute data relating to said particular attribute, which satisfies said condition concerning said date and time, attribute data which is common to said third attribute data stored in said first result storage and said fourth attribute data stored in said second result storage, and storing the specified attribute data into a search result storage; and
generating and outputting output data containing an attribute value contained in said attribute data stored in said search result storage.

13. The program as set forth in claim 12, wherein in said generating and outputting, if output instruction data of said data concerning said valid period of said attribute value is included in said search request data, said output data is generated so as to include said attribute value contained in said attribute data stored in said search result storage and said data concerning said valid period of said attribute value.

14. A data processing apparatus, comprising:
a unit that receives first request data containing at least a first attribute value and concerning registration of an attribute into a particular entry, and stores said first request data into a request data storage;
a unit that generates first attribute data containing at least said first attribute value and data concerning a valid period of said first attribute value, and stores said first attribute data into a first attribute table; and
a unit that stores an address of said first attribute table storing said first attribute data, into an attribute management table corresponding to said particular entry.

15. The data processing apparatus as set forth in claim 14, further comprising:
a unit that receives second request data containing at least a second attribute value and concerning an update of an attribute value for a particular attribute registered in said particular entry, and stores said second request data into said request data storage;
a registering unit that registers an end date and time of said valid period of said attribute value for attribute data containing a currently valid attribute value for said particular attribute;
a generating unit that generates second attribute data containing at least said second attribute value and a start date and time of said valid period of said second attribute value, based on said second request data stored in said request data storage, and stores said second attribute data into a second attribute table; and
a unit that stores an address of said second attribute table storing said second attribute data, into said attribute management table corresponding to said particular entry.

16. The data processing apparatus as set forth in claim 15, wherein said registering unit comprises:
a unit that copies attribute data containing said currently valid attribute value for said particular attribute; and
a unit that registers said end date and time of said valid period of said attribute value in the original attribute data, and
wherein said generating unit generates said second attribute data by using the copied attribute data.

17. The data processing apparatus as set forth in claim 14, further comprising:
a unit that receives search request data containing at least a condition concerning a date and time, and stores said search request data into a search request data storage;
a unit that extracts attribute data containing data concerning a valid period, which satisfies said condition concerning said date and time, based on said search request data stored in said search request data storage, and stores the extracted attribute data into a result storage; and
a unit that generates and outputs output data containing an attribute value contained in said attribute data stored in said result storage.

18. The data processing apparatus as set forth in claim 14, further comprising:
a unit that receives search request data containing a condition concerning a date and time for a particular attribute, and stores said search request data into a search request data storage;
a unit that extracts third attribute data containing data concerning a valid period, which satisfies said condition concerning said date and time, in accordance with said search request data stored in said search request data storage, and stores said third attribute data into a first result storage;
a unit that extracts fourth attribute data relating to said particular attribute in accordance with said search request data stored in said search request data storage, and stores the fourth attribute data into a second result storage;
a unit that specifies, as attribute data relating to said particular attribute, which satisfies said condition concerning said date and time, attribute data which is common to said third attribute data stored in said first result storage and said fourth attribute data stored in said second result storage, and stores the specified attribute data into a search result storage; and
an output unit that generates and outputs output data containing an attribute value contained in said attribute data stored in said search result storage.

19. The data processing apparatus as set forth in claim 18, wherein if output instruction data of said data concerning said valid period of said attribute value is included in said search request data, said output unit generates said output data so as to include said attribute value contained in said attribute data stored in said search result storage and said data concerning said valid period of said attribute value.
